(19) United States
(12) Patent Application Publication
(10) Pub. No.: US 2019/0019058 A1
(43) Pub. Date: Jan. 17, 2019

(54) SYSTEM AND METHOD FOR DETECTING HOMOGLYPH ATTACKS WITH A SIAMESE CONVOLUTIONAL NEURAL NETWORK

(71) Applicant: Endgame, Inc., Arlington, VA (US)

(72) Inventors: Jonathan Woodbridge, Corte Madera, CA (US); Anjum Ahuja, Los Gatos, CA (US); Daniel Grant, San Francisco, CA (US)

(73) Assignee: Endgame, Inc.

(21) Appl. No.: 15/649,348

(22) Filed: Jul. 13, 2017

(51) Int. Cl. G06K 9/48; G06F 21/62; G06F 17/30; G06F 21/12; G06T 7/168

(52) U.S. Cl. CPC G06K 9/481; G06F 21/6263; G06T 7/168; G06F 17/30271; G06F 21/128; G06F 17/30324

(57) ABSTRACT

The present invention utilizes computer vision technologies to identify potentially malicious URLs and executable files in a computing device. In one embodiment, a Siamese convolutional neural network is trained to identify the relative similarity between image versions of two strings of text. After the training process, a list of strings that are likely to be utilized in malicious attacks are provided (e.g., legitimate URLs for popular websites). When a new string is received, it is converted to an image and then compared against the image of list of strings. The relative similarity is determined, and if the similarity rating falls below a predetermined threshold, an alert is generated indicating that the string is potentially malicious.

### FIELD OF THE INVENTION

The present invention utilizes computer vision technologies to identify potentially malicious URLs and executable files on a computing device.

### BACKGROUND OF THE INVENTION

Cyber attackers utilize increasingly creative attacks to infiltrate computers and networks. One simple attack is a homoglyph (name spoofing) attack. Homoglyph (or name spoofing) attacks are a common technique used by attackers to obfuscate malware and malicious domain names. The attacker creates a process or domain name that look visually similar to a legitimate and recognized name, and typically sends that name in an email to a user, hoping that the user views the email as legitimate and clicks on a link or file name, which then causes malware to be released on the user's computer and network.

Attackers may use simple replacements such as “0” for “o”, “rn” for “m”, and “cl” for “d”. Swaps that may also include unicode characters that look very similar to common ASCII characters such as “ł” for “l”. Other attacks append characters to the end of a name that seem valid to a user such as “svchost32.exe”, “svchost64.exe”, and “svchost1.exe”, which to a user may appear to be the common Windows system process “svchost.exe”. The cyber attacker hopes that these processes or domain names will go undetected by users and security organizations by blending in as legitimate names.

The prior art has been relatively ineffective in combatting such malware. One prior art approach is to calculate the edit distance (or Levenshtein distance) of each new process or domain name to each member of a set of processes or domain names to monitor (i.e., common processes or domain names that are likely to be spoofed). This prior art approach is depicted in FIG. 1. In edit distance system 100, an edit distance module 130 receives a legitimate URL, such as www.endgame.com and a URL of interest, such as www.enclgame.com. Edit distance module 130 measures the number of edits to convert one string to another (i.e., the number of inserts, deletes, substitutions and transpositions of adjacent characters). Any distance less than or equal to some threshold is flagged as a spoofing attack. This prior art approach suffers from a poor False Positive (FP)/False Negative (FN) tradeoff. In addition, if attackers discover the threshold, they can craft spoofing attacks to always be greater than the threshold. For example, if the threshold is set to an edit distance of 2, then an attacker will make sure that all spoofing names are at least edit distance 3 from the process name they are spoofing.

Another prior art approach is to create a custom edit distance function that accounts for the visual similarity of substitutions, so that substituting a character with a visually similar character results in a smaller edit distance than a visually distinct character. However, this prior art technique results only in modest improvements over standard edit distance function of FIG. 1. In addition, these techniques require human labor and are not readily automated.

What is needed is an improved system and method that accurately identifies potential spoof attacks based on the visual similarity of a received character string with a set of known, valid strings.

### BRIEF SUMMARY OF THE INVENTION

The embodiments described herein utilize computer vision technologies to identify potentially malicious URLs and executable files before a user inadvertently enables the malicious attack. A Siamese convolutional neural network is trained to identify the relative similarity between image versions of two strings of text. After the training process, a list of strings that are likely to be utilized in malicious attacks are provided (e.g., legitimate URLs for popular websites) and indexed. When a new string is received, it is converted into an image and then compared against the image of list of strings. The relative similarity is determined, and if the similarity rating falls below a predetermined threshold, an alert is generated indicating that the string is potentially malicious.

### BRIEF DESCRIPTION OF THE DRAWINGS

FIG. 1 depicts a prior art edit distance system.

FIG. 2 depicts an inventive method of detecting homoglyph attacks using a Siamese neural network.

FIG. 3 depicts a training phase of an inventive system for detecting homoglyph attacks using a Siamese neural network.

FIG. 4 depicts an initialization phase of an inventive system for detecting homoglyph attacks using a Siamese neural network.

FIG. 5 depicts an implementation phase of an inventive system for detecting homoglyph attacks using a Siamese neural network.

FIG. 6 depicts components of an exemplary computing device for implementing the embodiments of FIGS. 2-5.

FIG. 7 depicts an example equation used by a Siamese convolutional neural network for computing dissimilarity between a pair of images.

FIG. 8 depicts an example loss function used to train a Siamese convolutional neural network for computing dissimilarity between a pair of images.

FIG. 9 depicts a model used by a Siamese convolutional neural network.

FIG. 10 depicts an example of the training process for a Siamese convolutional neural network using a pair of input strings.

FIG. 11 depicts an example of a KD Tree used for indexing.

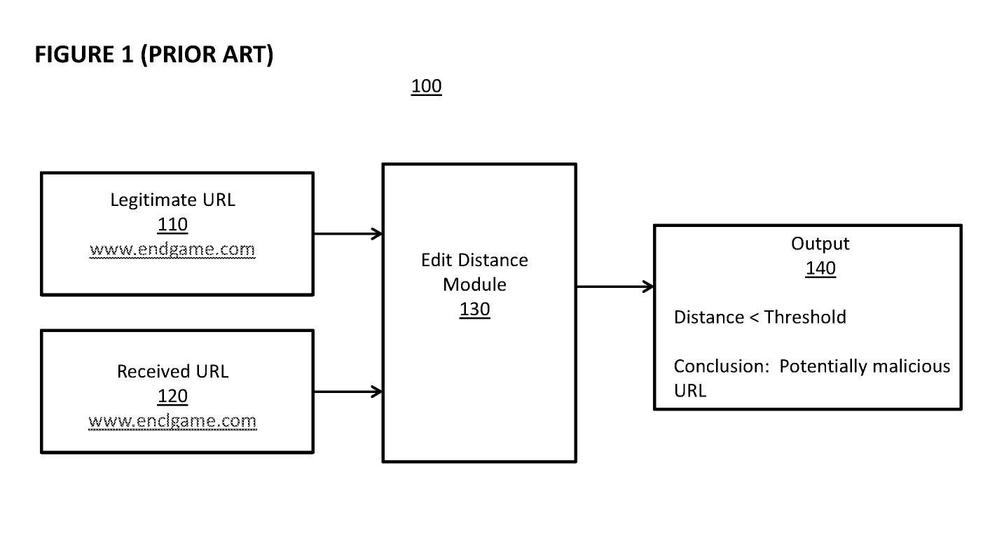

### DETAILED DESCRIPTION OF THE INVENTION

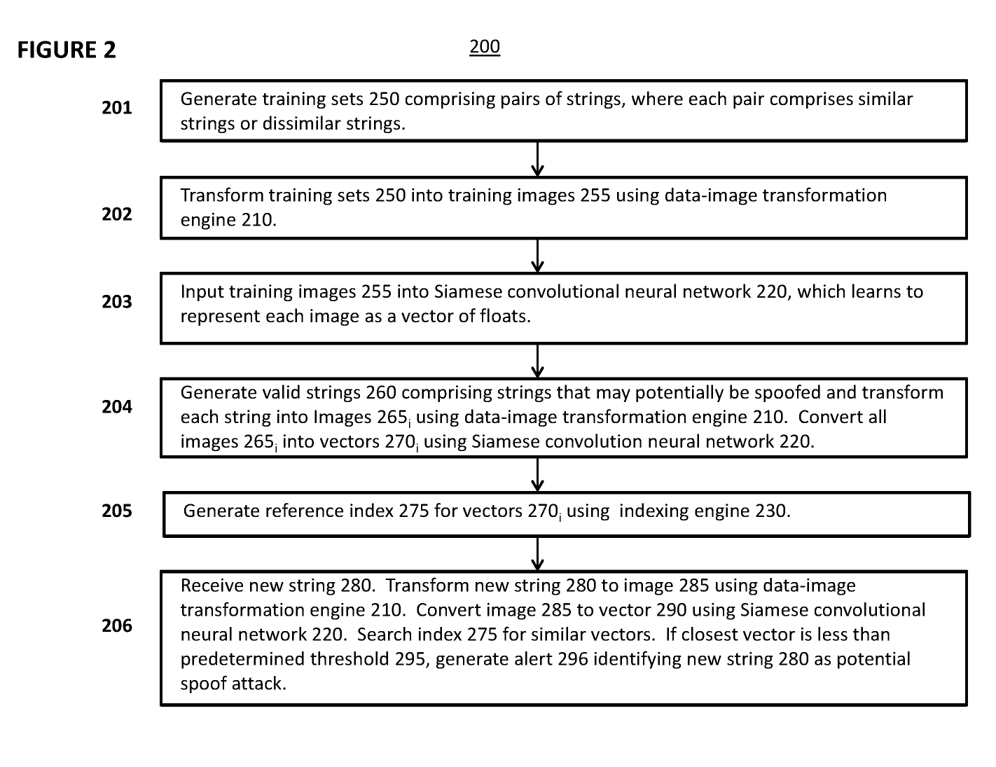

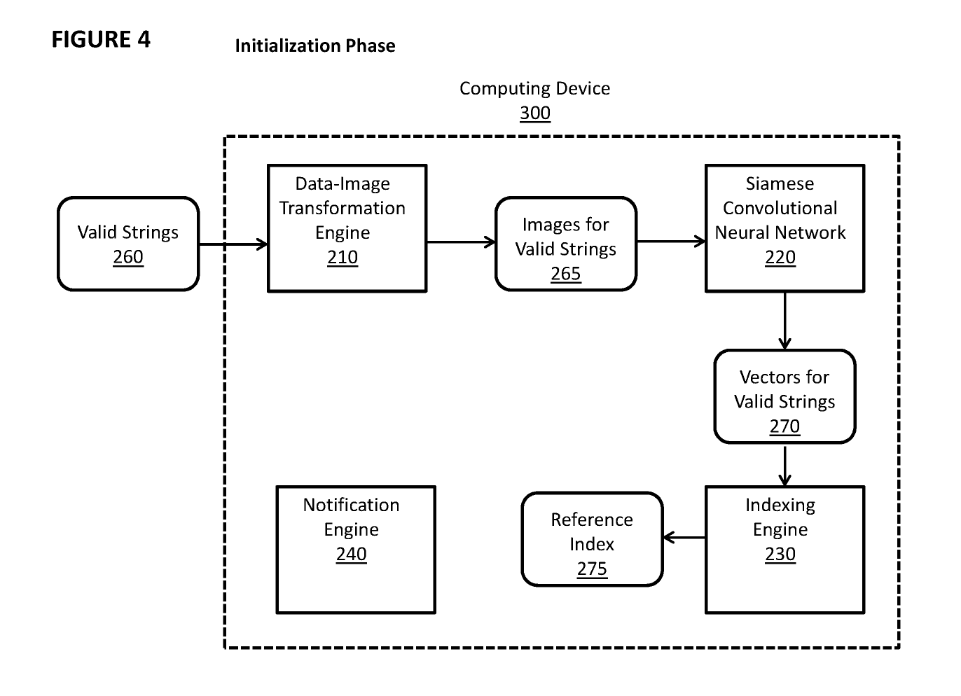

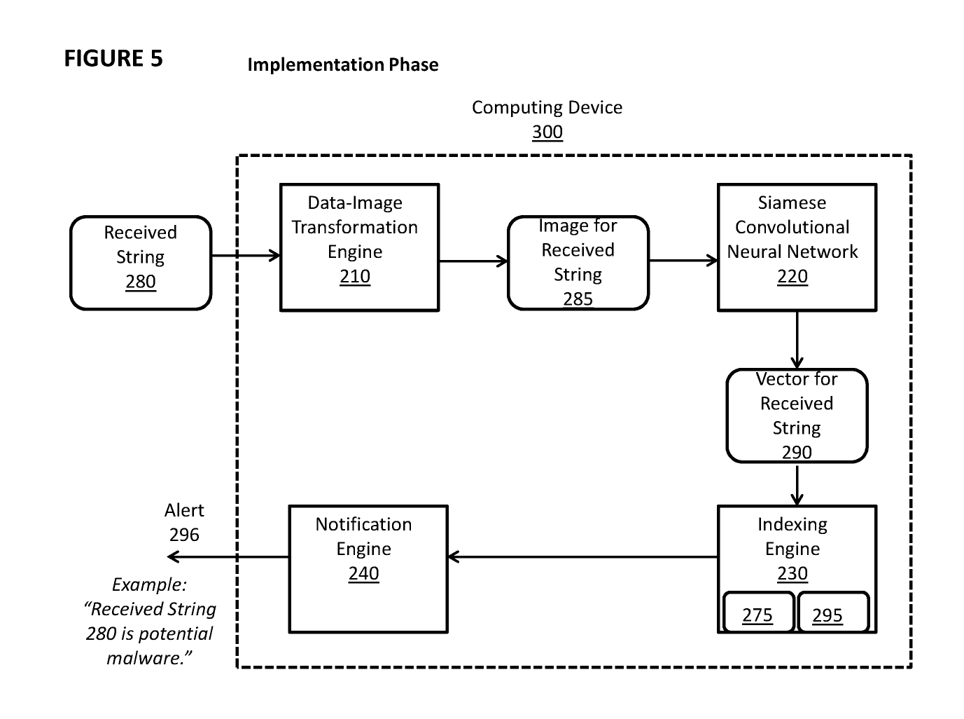

FIGS. 2-6 depict an embodiment of a method and system for detecting homoglyph attacks using a Siamese neural network.

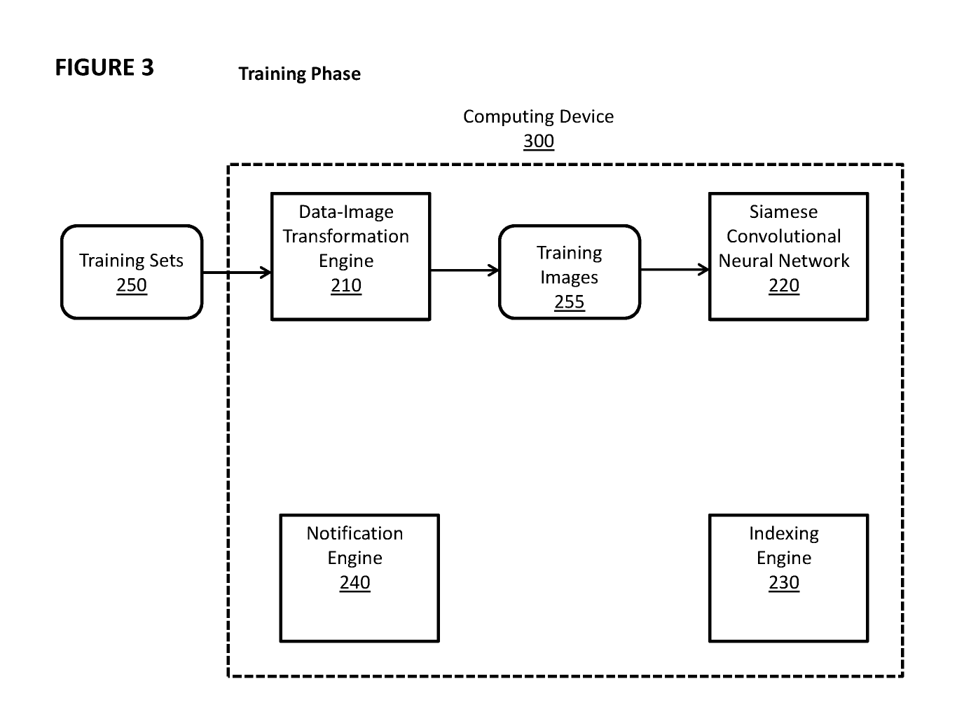

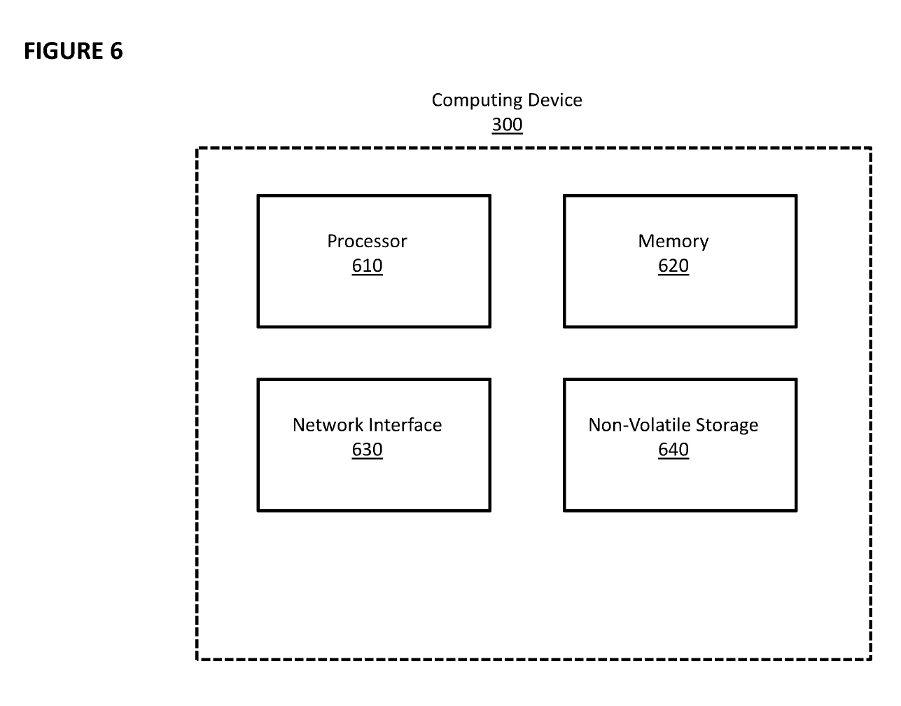

FIG. 2 depicts detection method 200. Detection method 200 is implemented by computing device 300 depicted in FIGS. 3-6. With reference to FIG. 6, computing device 300 comprises processor 610, memory 620, network interface 630, and non-volatile storage 640. Processor 610 comprises one or more CPU cores. Memory 620 comprises memory such as DRAM or SRAM memory. Network interface 630 comprises a wired or wireless interface for connecting computing device 300 to a network. Non-volatile storage 640 comprises one or more hard disk drives, solid state drives, RAIDs, or other non-volatile storage devices. Computing device 300 can be a server, desktop, notebook, mobile device, or other type of computer.

With reference to FIGS. 3-6, computing device 300 further comprises data-image transformation engine 210, Siamese convolutional neural network 220, indexing engine 230, and notification engine 240, each of which comprises lines of code stored in memory 620 and/or non-volatile storage 640 and executed by processor 610.

With reference to FIG. 2, the first step in detection method 200 is to generate training sets 250 comprising pairs of strings, where each pair comprises similar strings or dissimilar strings (step 201). An example of a pair of similar strings might be “google.com” and “gooogle.com”. An example of a pair of dissimilar strings might be “google.com” and “cnn.com.”

The second step is to transform training sets 250 into training images 255 using data-image transformation engine 210 (step 202). In this embodiment, each string is rendered into an image of fixed size (e.g., 150 pixels across×12 pixels high) using a common font (e.g., Anal TrueType font). The image optionally is a black-and-white bitmap image of the string. The image also could be a grayscale bitmap image of the string. The image could also be a multi-channel image using different fonts case.

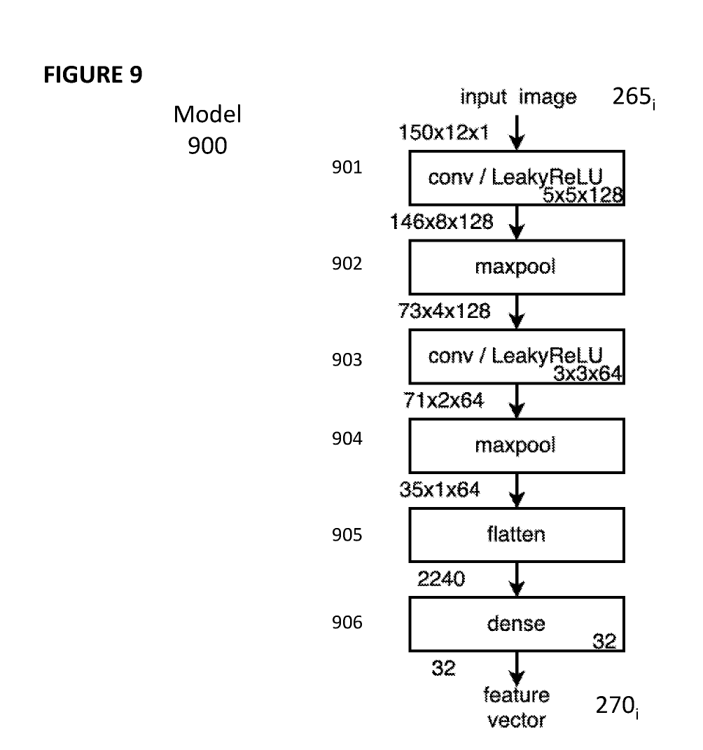

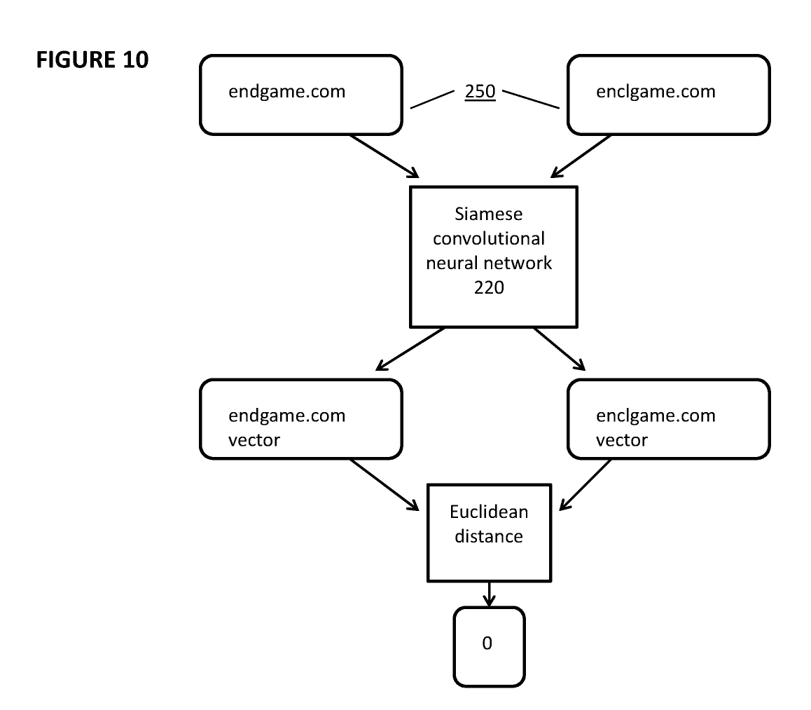

The third step is to input training images 255 into Siamese convolutional neural network 220, which learns to represent each image as a vector of floats (step 203). The vector might comprise, for example, 64 numbers of 32 bits each. Siamese convolutional neural network 220 extracts image features from each image in training images 255. This is shown in greater detail in FIG. 9. FIG. 9 depicts model 900 upon which Siamese convolutional neural network 220 is based. Input image 265ᵢ is received. A first convolution layer with leaky ReLU activations is applied to input image 265ᵢ (step 901). Then a maxpooling function is applied (step 902). Then a second convolution layer with leaky ReLU activation is applied (step 903), followed by another maxpooling function (step 904). Then the data is flattened using a downsampling filter (step 905), followed by a single dense layer that maps the flattened output of the convolutional layers to a 32-dimensional feature vector (step 906), which is vector 270ᵢ. Other techniques can be utilized instead. For example, instead of applying a first convolution layer with leaky ReLU activations in step 901 and/or step 903, one could apply a first convolution layer ReLU instead. Another possibility is to apply additional convolution layers. Other techniques are possible.

The fourth step is to generate valid strings 260 comprising strings that may potentially be spoofed and transform each string into images 265ᵢ using data-image transformation engine 210, where i is the number of valid strings that are of interest. Images 265ᵢ are converted into vectors 270ᵢ using Siamese convolution neural network 220. (step 204). Valid strings 260 comprise process names and domain names that are of interest for monitoring purposes. This might include, for example, names we expect to be targeted in a spoof attack. This list is tractable as it is unlikely for an attacker to spoof a process name or domain name that is known by very few people. However, this list can easily grow into the hundreds of thousands. For example, someone interested in monitoring domain names may want to monitor the top 250;000 domains around the world (i.e., i=250,000).

The fifth step is to generate reference index 275 for vectors 270ᵢ using indexing engine 230 (step 205).

The sixth step is to receive new string 280. New string 280 is transformed into image 285 using data-image transformation engine 210. Image 285 is converted to vector 290 using Siamese convolutional neural network 220. Index 275 is searched for similar vectors, and strings are reported for which the Euclidean distance between the vector for the new string 280 and the string stored in reference index 275 is below a predefined threshold. If the closest vector is less than predetermined threshold 295, alert 296 is generated identifying new string 280 as potential spoof attack. (step 206).

In step 206, new string 280 can be received from a variety of sources. For example, all potential URLs and file names in all emails received by an email server can be sent to computing device 300 as new strings 280 so that a determination can be made as to whether any of them are likely spoofs. In this configuration, computing device 300 might itself be part of an email server or web server. Any documents to be stored to a file server also can be analyzed for URLs and file names, and those can be sent to computing device 300 as new strings as well. In this configuration, computing device 300 might itself be part of a file server. In short, any string can be checked by computing device 300, and the location of computing device 300 within a network is flexible.

In step 206, predetermined threshold 295 optionally can be selected by a user or administrator. A lower predetermined threshold 295 will result in fewer false positives, but at the expense of increased false negatives. A higher predetermined threshold 295 will result in increased false positives but fewer false negatives.

In step 206, alert 296 can take many possible forms. For example, a message can be displayed on the screen of a user's device, or a text or email can be sent to a user or administrator, or an audible noise can be generated on the computer of a user or administrator.

Additional detail will now be provided regarding an embodiment of Siamese convolutional neural network 220. Siamese convolutional neural network 220 follows traditional techniques for such networks. At its core, a Siamese neural network is simply a pair of identical neural networks (i.e., shared weights) which accept distinct inputs, but whose outputs are merged by a simple comparative energy function. The key purpose of the neural network is to map a high-dimensional input (e.g., an image) into a target space, such that a simple comparison of the targets by the energy function approximates a more difficult-to-define “semantic” comparison in the input space.

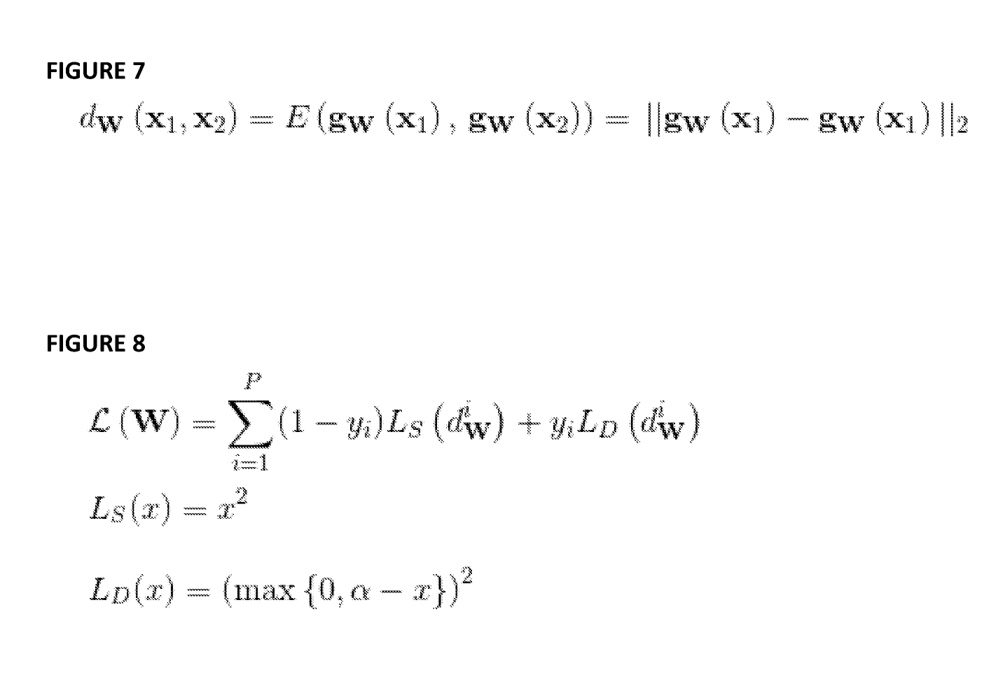

Mathematically, if a neural network g_{W}: Rⁿ→R^{d} is parameterized by weights W, and we choose simple Euclidean distance for our comparative energy function E: R^{d}×R^{d}→R, then the Siamese network computes dissimilarity between the pair of images (x1; x2) using the equation shown in FIG. 7. Note that g_{W} represents a family of functions parameterized by W. We wish to learn W such that d_{W}(x₁; x₂) is small if x₁ and x₂ are similar, and large if they are dissimilar. At first glance, one may be tempted to choose W simply minimizing d_{W} over pairs of inputs; however, this may lead to degenerate solutions such as g_{W}=constant, for which d_{W} is identically zero. Instead, previous research has employed contrastive loss to ensure that similar inputs result in small d_{W}, while simultaneously pushing dW to be large for dissimilar inputs. The inventors of the present application have concluded that the best mode is for partial loss for similar pairs to be squared loss, L_{S}(x)=x², while partial loss for dissimilar pairs was chosen to be the squared hinge loss with margin α, using the formula found in FIG. 8. Other loss function can be used instead. For example, one instead could use absolute loss, where Ls(x)=|x|.

Since the loss function is differentiable with respect to W, the weights can be learned via backpropagation. Notable is the fact that after the weights W have been trained, the network g_{W} may be used in isolation to map from the space of images to the compact target feature space for simple comparison.

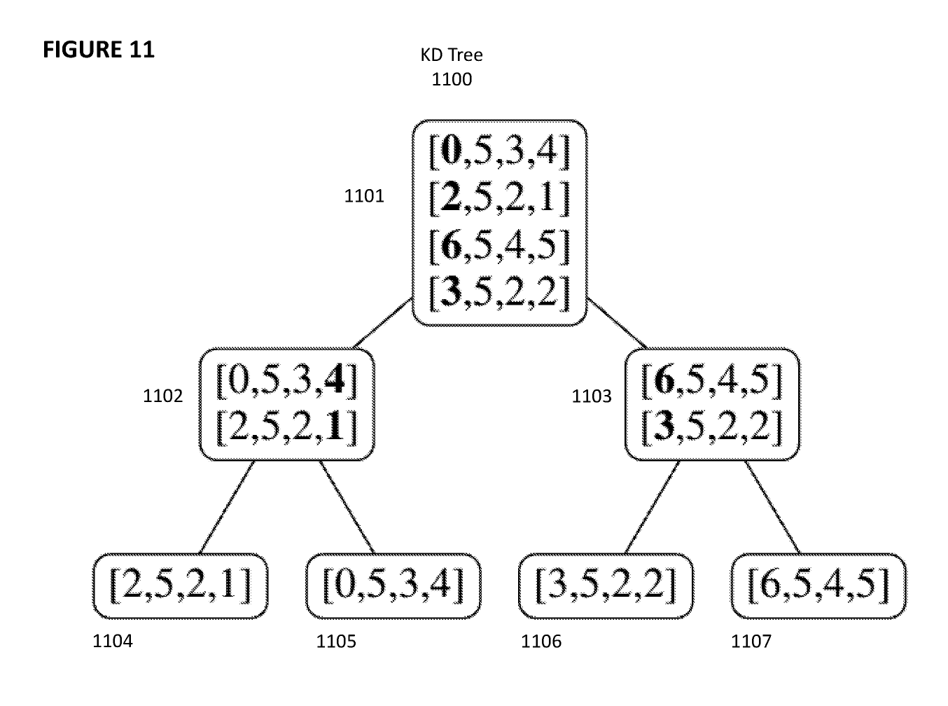

An example of the training process for Siamese convolutional neural network 220 is shown in FIG. 11. An exemplary pair of strings (endgame.com and enclgame.com) in training set 250 is shown. The pair is input to Siamese convolutional neural network 220, which generates vectors of float for each string. The Euclidian distance is determined by those vectors and determined to have a value of “0,” signifying that the two strings are similar.

Additional detail is now provided regarding indexing engine 230. In a preferred embodiment, indexing engine 230 uses a geometrical index called (randomized) KD-Trees. KD-Trees are an indexing technique for vectors. The most basic technique is deterministic and works by splitting a dataset into two groups along the median of the dimension with the highest variation. Each of these two groups are then split in the same fashion. This splitting continues until groups are split to a single element resulting in a binary tree. Several randomization techniques can be applied to this strategy resulting in a nondeterministic tree. Several random trees can be built on the same data and used in concert to improve search quality. Other indexing schemes can be used instead, such as multidimensional indexing schemes that utilize: point quadtrees; R, R*, or R+ Trees; SS or SR trees; M Trees; or other known indexing schemes.

FIG. 12 shows a basic KD-Tree 1200 built from four feature vectors. The root node 1201 is split along the mean of the first dimension as it has the highest standard deviation. A similar process occurs for each of the root's children 1202 and 1203, resulting in four leaves 1204, 1205, 1206, and 1207. Each node in the tree contains the split dimension and the value along that dimension to split on. When the index is queried with a feature vector, the query begins at the root and traversing to the child that the query is split to. This process continues until the query hits a leaf. KD-Trees have a notion of checks to account for the approximate nature of the index. The idea is that for each query, multiple leaf nodes within a tree are visited and the best match among those leaves is returned. While a query is traversing, it stores the distance of the query to the split point for each node. When a query hits a leaf and has more checks remaining, it restarts a query at the node where the split point was closest to the query. KD-Trees, and geometrical indexes in general, have been controversial as they do not have theoretical bounds on the computational performance.

As discussed above with reference to step 204 in FIG. 2, potential targets of spoofing attacks are converted to vectors 270 by the Siamese convolutional neural network. Vectors 270 are indexed using ten randomized KD-Trees, where each tree is grown to purity (1 sample per leaf node). In this embodiment, 128 checks on each query are performed.

In addition to specific examples discussed above, the technology described herein can be extended to all spoofing attempts that take advantage of a user's implicit trust in any document or website that appears to contain a legitimate name, particularly a well-known brand name. For instance, malicious websites often will use domain names that are homoglyphs of legitimate names or will contain links that use homoglyphs of legitimate names. It also is common for apps to be made available in an app store or cloud service where the app name includes a homoglyph of a legitimate name. It also is conceivable that a user could obtain a malicious communication that utilizes a homoglyph of a legitimate name on the letter head of an electronic or physical letter. In each of these instances, the techniques of this invention can be used to detect potentially malicious content.

It is to be understood that the present invention is not limited to the embodiment(s) described above and illustrated herein, but encompasses any and all variations evident from the above description. For example, references to the present invention herein are not intended to limit the scope of any claim or claim term, but instead merely make reference to one or more features that may be eventually covered by one or more claims.

What is claimed is:

1. A method for identifying a potential homoglyph attack using a computing device comprising a Siamese convolutional neural network and an index engine, the method comprising:
receiving, by a computing device, a string of characters;
transforming, by the computing device, the string of characters into a received image;
transforming, by the Siamese convolutional neural network, the image into a received vector; and
searching, by the index engine, a reference index and generating an alert if the distance between the received vector and any of the vectors referenced in the reference index is below a predetermined threshold.

2. The method of claim 1, wherein the received string of characters is a URL.

3. The method of claim 1, wherein the received string of characters is a file name.

4. The method of claim 1, wherein the received image is a bitmap image.

5. The method of claim 1, wherein the received image is a grayscale image.

6. The method of claim 1, wherein the received image is a multi channel image.

7. The method of claim 1, wherein the index engine utilizes a KD Tree index.

8. The method of claim 1, wherein the index engine utilizes a multidimensional index.

9. A method for training a Siamese convolutional neural network in a computing device and for using the Siamese convolutional neural network to identify a potential homoglyph attack, the method comprising:
receiving, by the computing device, a set of pairs of strings;
transforming, by the computing device, each string in the set of pairs of strings into an image to create a set of pairs of images;
training the Siamese convolutional neural network using the set of pairs of images;
receiving, by the computing device, a string of characters;
transforming, by the computing device, the string of characters into a received image;
transforming, by the Siamese convolutional neural network, the image into a received vector; and
searching, by the index engine, a reference index and generating an alert if the distance between the received vector and any of the vectors referenced in the reference index is below a predetermined threshold.

10. The method of claim 9, wherein the received string of characters is a URL.

11. The method of claim 9, wherein the received string of characters is a file name.

12. The method of claim 9, wherein the received image is a bitmap image.

13. The method of claim 9, wherein the received image is a grayscale image.

14. The method of claim 9, wherein the received image is a multi channel image.

15. The method of claim 9, wherein the index engine utilizes a KD Tree index.

16. The method of claim 9, wherein the index engine utilizes a multidimensional index.

17. A computing device for identifying a potential homoglyph attack, comprising:
a data-image transformation engine comprising instructions for transforming a received string of characters into an image;
a Siamese convolutional neural network configured to convert an image into a vector;
an indexing engine for comparing the vector to a set of indexed vectors; and
a notification engine for generating an alert if the difference between the vector and any of the indexed vectors is below a predetermined threshold.

18. The device of claim 17, wherein the received string of characters is a URL.

19. The device of claim 17, wherein the received string of characters is a file name.

20. The device of claim 17, wherein the received image is a bitmap image.

21. The device of claim 17, wherein the received image is a grayscale image.

22. The device of claim 17, wherein the index engine utilizes a KD Tree index.
